(19) United States
(12) Patent Application Publication
(10) Pub. No.: US 2017/0091490 A1
(43) Pub. Date: Mar. 30, 2017

(54) Methods And Systems For Displaying Private Information

(71) Applicant: Lunatech, LLC, Studio City, CA (US)

(72) Inventor: John Cameron, Studio City, CA (US)

(21) Appl. No.: 15/276,311

(22) Filed: Sep. 26, 2016

Related U.S. Application Data
(60) Provisional application No. 62/232,084, filed on Sep. 24, 2015.

(51) Int. Cl. G06F 21/84; A24F 47/00; G09G 3/20

(52) U.S. Cl. CPC G06F 21/84; G09G 3/2096; A24F 47/004; G09G 2358/00

(57) ABSTRACT

Provided are systems, methods, and devices for deployment of an integrated hardware and software system where an electronic device display is at least one of electronically coded, scrambled or blacked out enabling a user wearing decoding glasses to synch to the device in a matching process to realize viewing the electronic device display by the user.

### CROSS REFERENCE TO RELATED PATENT APPLICATION

This application claims priority to U.S. Provisional Application No. 62/232,084 filed Sep. 24, 2015, here incorporated by reference in its entirety.

### BACKGROUND

As portable computing devices become more ubiquitous, users more often access private information in public locations. Users may be unaware of other people or cameras that are able to view a user's private information while the user is operating the portable device. Thus, there is need for methods and systems that allow greater security in displaying information to users.

### SUMMARY

It is to be understood that both the following general description and the following detailed description are exemplary and explanatory only and are not restrictive, as claimed. Provided are methods and systems for deployment of an integrated hardware and software system where an electronic device display is at least one of electronically coded, scrambled or blacked out enabling a user wearing decoding glasses to synch to the device in a matching process to realize viewing the electronic device display by the user.

In an aspect, an example method for providing a secure display can comprise determining a security scheme associated with a decoding device, accessing data, modifying the data based on the security scheme, and providing the modified data to a display device.

In an aspect, an example method for interpreting a secure display can comprise receiving a signal from a computing display. The signal can comprise data encoded using a security scheme. The method can comprise modifying the signal based on the security scheme and providing the modified signal to a user viewing the computing display.

In an aspect, an example system can comprise a display configured to display (e.g., project) data upon a screen, a memory having encoded thereon computer-executable instructions, and a processor functionally coupled to the memory and configured, by the computer-executable instructions, to perform at least the following actions: determining a security scheme associated with a decoding device, accessing data, modifying the data based on the security scheme, and providing the modified data to the display.

In an aspect, an example decoding device can comprise at least one lens, a support frame configured to support the lens, and a filter configured to modify information received from a display.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a diagram illustrating an example secure display system;

FIG. 2 is a diagram illustrating another view of the example secure display system;

FIG. 3 is a flowchart illustrating an example method for providing a secure display;

FIG. 4 is a flowchart illustrating example method for interpreting a secure display; and

FIG. 5 is a block diagram illustrating an example computing environment in which the present methods and systems can operate.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also he loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure pertains to creation of a device blackout system which enables only a person wearing a special set of decoder glasses to be able to read the contents of a blacked out, digitally camouflaged and/or coded screen. In an aspect, the blacked out, digitally camouflaged and/or coded screen can comprise a static pattern, an active/animated pattern, and combinations thereof.

The present disclosure, in accordance with one aspect pertains to the creation and operation of a system where at least one of a software or a hardware solution is deployed in order to make a device display (e.g., screen, monitor) unreadable by virtue of color, coding, scrambling, a static pattern, an active/animated pattern, a combination thereof, and/or the like where the device screen can be read by a user. For example, the device (e.g., device display) can be synched with or otherwise configured to match a mode of scrambling decodable by a set of glasses designed to match the unscrambling of the scrambled, coded and/or blacked out device screen.

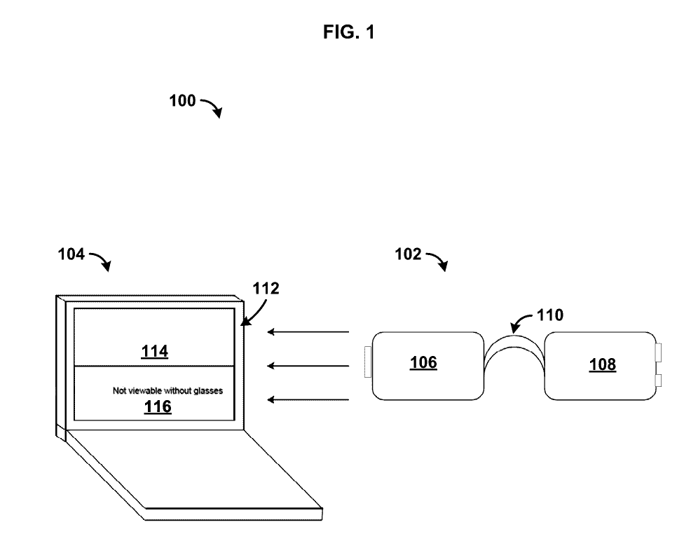

FIG. 1 is a diagram illustrating an example secure display system 100. The system 100 can comprise glasses 102 (e.g., or other decoding device, wearable device, contact lens) and a computing device 104. The glasses 102 can comprise one or more lens, such as a left lens 106 and a right lens 108. The left lens 106 and the right lens 108 can be connected to each other by abridge 110. In an aspect, the bridge 110 can be configured to support the one or more lens by resting on a feature of a user, such as a portion of the user's face (e.g., nose). The one or more lens can be any appropriate shape, such as circular, rectangular, triangular, and/or the like. The glasses 104 can portable, light weight, conform to a human face, and/or the like.

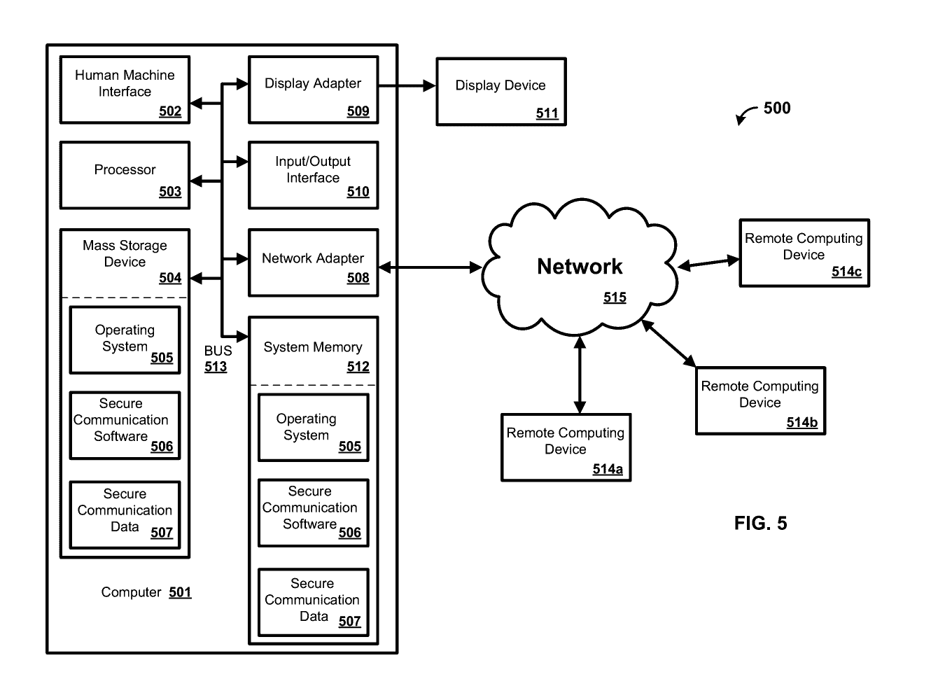

In an aspect, the computing device 104 can comprise a processor, memory, peripheral devices (e.g., keyboard), and/or the like as shown in FIG. 5). The computing device 104 can comprise a display 112. The display 112 can comprise a light emitting diode (LED) display, organic LED display, liquid crystal display, a combination thereof, and/or the like.

The computing device 104 can comprise a laptop, mobile device, smart device (e.g., smart phone, smart watch, smart apparel), computing station, transportation media device (e.g., device for displaying media in a car, airplane, train, boat, and/or the like). The computing device 104 can comprise a vaping device. The vaping device can comprise a device configured to generate a vapor based on a liquid, solid, and/or other solution. The vapor can comprise a substance desired for inhalation. As a further example, the computing device 104 can comprise a screen on an electronic communication device (e.g., mobile phone, smart phone, smart apparel) configured with vaping functionality (e.g., having components such as a wick, heating element, solution, and/or the like for generating a vapor for inhalation by a user). For example, display 112 can comprise a display on a vaping device and/or a display on a communication device configured with vaping functionality.

In an aspect, the glasses 102 and the computing device 104 can be configured with a reciprocal functionality for communicating data (e.g., text, images, video, audio), which allows the glasses 102 to decipher the data being transmitted onto and/or from the display 112. In an aspect, this reciprocal functionality may be implemented using a display as disclosed on the following webpage http://alumni.media.mit.edu/˜dlanman/research/compressivedisplays/, the entirety of which is herein incorporated by reference

By way of further explanation, the display 112 can comprise a “holographic” 3D display configured to depict 3D scenes, with or without the use of glasses (e.g., eye glasses), using optimized optical hardware and co-designed “compressive” image-encoding algorithms. For example, the display 112 can comprise a compressive display. An example compressive display can be fabricated by comprising multiple layers of liquid crystal displays (LCDs). In an aspect, the display can render 3D images based on tensor algebra (a mathematical framework previously applied to compress complex, high-dimensional data sets). For example, the display 112 can render 3D images based on nonnegative tensor factorization (NTF).

In an aspect, the display 112 can comprise a tensor display. The display 112 can comprise a compressive light field display. The display 112 can comprise one or more stacks of time-multiplexed, light-attenuating layers illuminated by uniform or directional backlighting (e.g., any low-resolution light field emitter). An example tensor display is further described in “Tensor Displays: Compressive Light Field Synthesis using Multilayer Displays with Directional Backlighting” by G. Wetzstein et al published online at http://alumni.media.mit.edu/˜dlanman/research/compressivedisplays/papers/Tensor_Displays.pdf the entirety of which is herein incorporated by reference.

In an aspect, the display 112 can utilize polarization fields as an optically-efficient construction for light field display with layered LCDs. Such displays can comprise a stack of liquid crystal panels with a pair of crossed polarizers, with layers acting as spatially-controllable polarization rotators. Example use of polarization fields is described further in “Polarization Fields: Dynamic Light Field Display using Multi-Layer LCDs” by D. Lanman, et al., published online at http://alumni.media.mit.edu/˜dlanman/research/compressivedisplays/papers/Polarization_yields.pdf, the entirety of which is herein incorporated by reference.

In an aspect, the display 112 can utilize layered 3D approaches. For example, the display 112 can comprise an automultiscopic display. The automultiscopic display can comprise compact volumes of light-attenuating material. The display 112 can be fabricated by stacking transparencies. In such configuration, attenuators can recreate a light field when back-illuminated. In an aspect, the display 112 can utilize tomographic optimization configured to resolve inconsistent views, leading to brighter, higher-resolution 3D displays with greater depth of field and higher dynamic range. The use of layered 3D approaches is described further at “Layered 3D: Tomographic Image Synthesis for Attenuation-based Light Field and High Dynamic Range Displays” by G Wetzstein et al, published online at http://alumni.media.mit.edu/˜dlanman/research/compressivedisplays/papers/Layered3D.pdf, the entirety of which is herein incorporated by reference in its entirety.

In an aspect, the display 112 can be based on a high-rank 3d configuration. For example, a pair of modified LCD panels can be stacked. Rather than using heuristically-defined parallax barriers, layers can be simultaneously optimized for the multi-view content. This process leads to 3D displays with increased brightness and refresh rate. The use of high-rank 3D configuration is described in further detail in Lanman, D., Hirsch, M., Kim, Y., Raskar, R. 2010, “Content-Adaptive Parallax Barriers: Optimizing Dual-Layer 3D Displays using Low-Rank Light Field Factorization.” ACM Trans, Graph. 29, 6, Article 163 (December 2010), the entirety of which is herein incorporated by reference.

The reciprocal functionality may also be implemented using glasses 102 as disclosed in U.S. patent application Ser. No. 09/772,615, filed Jan. 30, 2001, entitled “Decryption Glasses,” the entirety of which is herein incorporated by reference. For example, the glasses 102 can comprise optical decryption glasses. The glasses 102 can comprise lenses that modify incident light emitted from the display. The glasses 102 can be configured to render (e.g., by modifying incident light) encrypted images appearing on the display that are undecipherable to the naked eye but decipherable when the display is viewed through the lenses. For example, the glasses 102 can modify an image projected by the display based on refraction, diffraction, and/or the like.

As another example, the glasses 102 can comprise smart glasses. The smart glasses can comprise a processor, memory, computer readable code, and/or the like. The glasses 102 can comprise one or more lens or other display device configured to render an image on or in front of an eye for viewing. The glasses 102 can receive the input image from a variety of sources, such as an optical character reader, bar code reader, or similar information reading device. The glasses 102 can perform decryption operations on the information received. Following decryption, the glasses 102 can display the decrypted images for the user.

In an aspect, the computing device 104 can be configured to authenticate the glasses 102. For example, the computing device 104 can he configured to “pair” with the glasses 102 via initiation of a pairing process by a user. The computing device 104 can be configured recognize an encrypted message broadcast from the glasses 102 (e.g., via RFID, Bluetooth, wireless). The computing device 104 can authenticate the glasses 102 using a public key infrastructure, private key infrastructure, and/or the like.

In an aspect, the glasses 102 can be configured to provide coding information to the computing device 104 to establish a secure mode of communication. For example, glasses 102 can provide (e.g., transmit) encryption keys, refraction settings, reflection settings, codec information, security tokens, and/or the like to the computing device 104.

In an aspect, the display 112 can be configured to display both secure and unsecure information simultaneously. For example, a first portion 114 of the display 112 can display information in an unsecure manner. For example, information (e.g., data, images, text, video) displayed in the first portion 114 can be discernible, decipherable, viewable, and/or the like by anyone within viewing range of the display 114. A second portion 116 of the display 112 can display information in a secure manner. For example, information (e.g., data, images, text, video) displayed in the first portion 116 can be indiscernible, undecipherable, unviewable, and/or the like by anyone within viewing range of the display 114. As a further explanation, the information displayed in the second portion 116 can be scrambled, encoded, encrypted, blocked, shaded, blacked out, distorted, and/or the like. The glasses 102 can be configured to decrypt, unlock, unshade, undistort, and/or the like the information displayed in the second portion 116 of the display. For example, the glasses 102 can comprise a hardware or software filter, utilize a decoding and/or decrypting algorithm or other mathematical formula (e.g. linear transformation, translation).

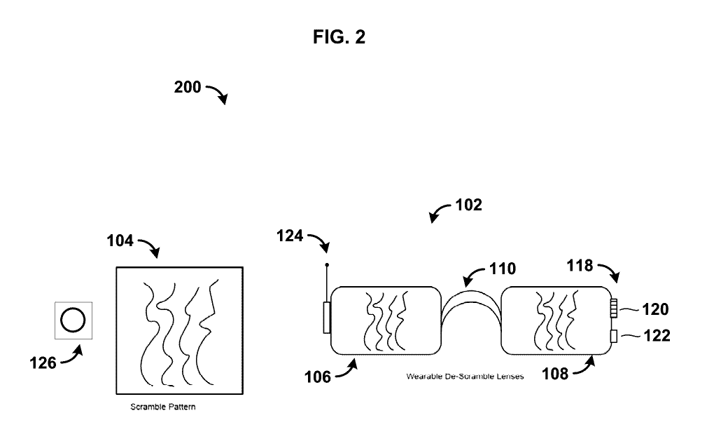

FIG. 2 is a diagram illustrating another view of the example secure display system 100. In an aspect, the glasses 102 comprise one or more descramble lens. For example, the left lens 106 and/or the right lens 108 can be configured to descramble an image, signal, and/or the like shown on the display 112. In an aspect, the left lens 106 and/or the right lens 108 can be configured to descramble a static pattern, an active/animated pattern, combinations thereof, and the like.

In an aspect, the computing device 104 can comprise an optical sensor 126. For example, the computing device 104 can read information related to the glasses 102 from the optical sensor 126. The information related to the glasses 102 can comprise an identifier, decryption settings, decoding settings, and/or the like. The optical sensor can be configured to read manipulable diffraction gratings, prism settings, and/or the like on the glasses based on a unique RFID, sensor code, a signal, an identifier, bio recognition (e.g., facial recognition), a combination thereof, and/or the like.

The computing device 104 can be configured to display secure information based on the information related to the glasses 102. For example, the display 112 can display text, images, video, or a combination thereof encrypted to match the decryption, coding, refraction setting, diffracting grating, prism settings, static pattern, active/animated pattern, and/or the like of the glasses thereby enabling the user (e.g., only the user, only users having the glasses 112) to view the secure information.

In an aspect, the glasses 102 can comprise a control system 118 comprising one or more controls 120 and 122 for adjusting properties and/or settings of the glasses. The one or more controls 120 and 122 can comprise at least one of a dial, a microphone (e.g., for voice command), a haptic sensor, pressure sensor, actuator, a switch control, or a combination thereof. The control system 118 can allow the user to select from a plurality of different combinations of settings. For example, the controls can be configured for grating manipulation, prism manipulation, and/or the like.

In an aspect, the glasses 102 can comprise a transceiver 124 configured to produce an encrypted setting signal. The setting signal can be received and read by the computing device 104. The setting signal can comprise encryption keys, diffraction settings, prisms settings, security scheme identifiers, and/or the like. The computing device 104 can encode, encrypt and/or otherwise modify data and display it for a user wearing the glasses 102. For example, upon reading the setting signal, the computing device 104 can programs the display 112 to encrypt, encode, modify, and/or the like data (e.g., matching the settings of the glasses) in a manner such that (e.g., only) the glasses 102 can decrypt and/or decode the data e.g., using the settings transmitted in the settings signal). As a further illustration, the computing device 104 can comprise a database. The database can comprise one or more security schemes, such as encryption schemes, encoding schemes, translation schemes, modification schemes, filter schemes, and/or the like. The computing device 104 can identify the appropriate security scheme to match the settings of the glasses 102. For example, the computing device 104 can identify the security scheme by querying a database to find a matching security scheme for communication with the glasses. The computing device 112 can deploy, enable, and/or otherwise use the security scheme to display the data on the display 112.

In an aspect, it should be noted that the user may change the security scheme during a viewing session at any time. The user can change the security scheme at least one time during a viewing session. The computing device 104 can detect the change and/or the glasses can notify the computing device 104 of the change in the security scheme. The computing device 104 can update display of the data based on the updated security scheme.

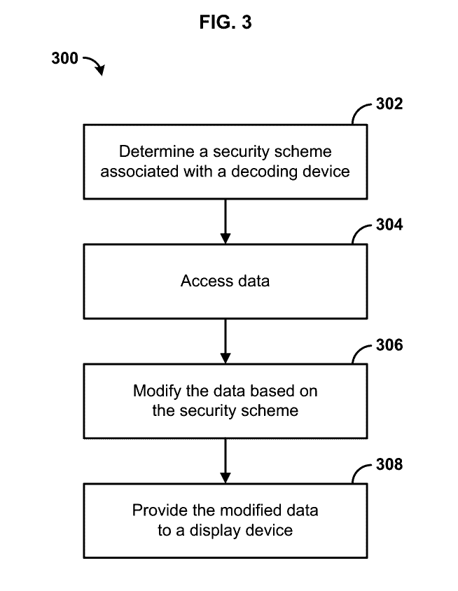

FIG. 3 is a flowchart illustrating an example method 300 for providing a secure display. At step 302, a security scheme associated with a decoding device can be determined. The decoding device can comprise eyeglasses configured to receive the modified data as displayed to a user and convert the modified data back to the original data for viewing by the user.

In an aspect, determining a security scheme associated with a decoding device can comprise detecting a setting of the decoding device. For example, detecting a setting of the decoding device can comprise detecting (e.g. receiving, accessing, finding) an identifier, a diffraction setting, a prism setting or a combination thereof using an optical sensor. The decoding device can transmit, project, and/or the like the setting. As another example, the optical sensor can be used to take an image (e.g., picture) of the decoding device. The image can be analyzed to determine information, symbols, identifiers, hardware configurations shown in the image. In an aspect, the image can comprise a static pattern, an active/animated pattern, combinations thereof, and the like.

At step 304, data can be accessed. For example, the data can be received from an application (e.g., based on user input). The data can be accessed from a hard disk, memory, and/or the like. The data can comprise images, data, text, video, and/or the like. For example, the data can comprise a graphical interface for providing information to the user.

At step 306, the data can be modified based on the security scheme. In an aspect, modifying the data based on the security scheme can comprise encrypting the data, encoding the data, or a combination thereof. Modifying the data based on the security scheme can comprise modifying the data to match a diffraction setting, a prism setting, a polarity setting, a static pattern, an active/animated pattern, a refraction setting, or a combination thereof.

At step 308, the modified data can be provided to a display device. For example, the modified data can be transmitted via a wireless network, a local bus, a wired connection, and/or the like. The data can be displayed on the display such that a user viewing the display is unable to decipher the data without the decoding device. The display device can comprise a screen on a vaping device. The vaping device can comprise a device configured to generate a vapor based on a liquid, solid, and/or other solution. The vapor can comprise a substance desired for inhalation. As a further example, the display device can comprise a screen on an electronic communication device mobile phone, smart phone, smart apparel) configured with vaping functionality.

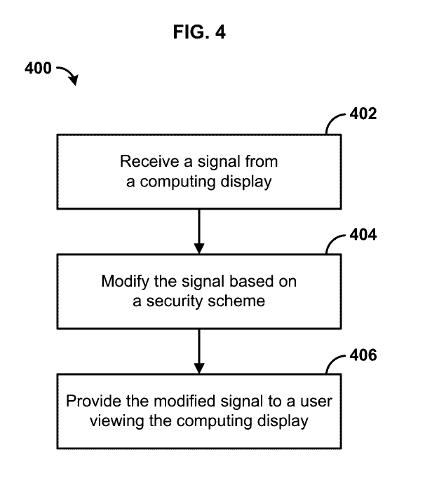

FIG. 4 is a flowchart illustrating example method 400 for interpreting a secure display. A decoding device, such as decoding glasses (e.g., worn by a user) can establish a secure protocol or security scheme for communication. In an aspect, information indicative of the security scheme can be transmitted to a computing device in communication with the computing display. For example, transmitting information indicative of the security scheme to a computing device in communication with the computing display can comprise transmitting an identifier, an encryption key, a codec, or a combination thereof to the computing device.

At step 402, a signal can be received from a computing display. The signal can comprise data encoded using a security scheme. In an aspect, the signal can be projected on a screen, from a screen, and/or the like of the display. In another aspect, the signal can be transmitted via a wireless protocol.

At step 404, the signal can be modified based on the security scheme. In an aspect, modifying the signal based on the security scheme can comprise filtering the signal. The signal can be filtered through a diffraction grating, a prism, or a combination thereof. For example, the diffraction grating, the prism, or both can be embedded in a lens. Modifying the signal based on a security scheme can comprise filtering an electromagnetic signal projected from the computing display. Filtering the electromagnetic signal projected from the computing display can comprise filtering the electromagnetic signal based on polarity, frequency, or a combination thereof.

In another aspect, modifying the signal based on the security scheme can comprise decoding the signal, decrypting the signal, or a combination thereof. In an aspect, the signal can comprise a static pattern, an active/animated pattern or a combination thereof. For example, the decoding device can comprise a memory (e.g. storing decryption keys, identifiers, settings) and a processor configured to modify the data based on hardware and/or software filtering, decryption, decoding, and/or the like.

At step 406, the modified signal can be provided to a user viewing the computing display. Providing the modified signal to the user viewing the computing display can comprise channeling the modified signal to at least a portion of an eye of the user.

In an exemplary aspect, the methods and systems can be implemented on a computer 501 as illustrated in FIG. 5 and described below. By way of example, the glasses 102 and the computing device 104 of FIG. 1 can be computers as illustrated in FIG. 5. Similarly, the methods and systems disclosed can utilize one or more computers to perform one or more functions in one or more locations. FIG. 5 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 501. The components of the computer 501 can comprise, but are not limited to, one or more processors 503, a system memory 512, and a system bus 513 that couples various system components including the one or more processors 503 to the system memory 512. The system can utilize parallel computing.

The system bus 513 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 513, and all buses specified in this description can also be implemented over a wired or wireless network connection and each of the subsystems, including the one or more processors 503, a mass storage device 504, an operating system 505, secure communication software 506, secure communication data 507, a network adapter 508, the system memory 512, an Input/Output Interface 510, a display adapter 509, a display device 511, and a human machine interface 502, can be contained within one or more remote computing devices 514a,b,c at physically separate locations, connected through buses of this form, in effect implementing a fully distributed system.

The computer 501 typically comprises a variety of computer readable media. Exemplary readable media can be any available media that is accessible by the computer 501 and comprises, for example and not meant to be limiting, both volatile and non-volatile media, removable and non-removable media. The system memory 512 comprises computer readable media in the form of volatile memory, such as random access memory (RAM), and/or non-volatile memory, such as read only memory (ROM). The system memory 512 typically contains data such as the secure communication data 507 and/or program modules such as the operating system 505 and the secure communication software 506 that are immediately accessible to and/or are presently operated on by the one or more processors 503.

In another aspect, the computer 501 can also comprise other removable/non-removable, volatile/non-volatile computer storage media. By way of example, FIG. 5 illustrates the mass storage device 504 which can provide non-volatile storage of computer code, computer readable instructions, data structures, program modules, and other data for the computer 501. For example and not meant to be limiting, the mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 504, including by way of example, the operating system 505 and the secure communication software 506. Each of the operating system 505 and the secure communication software 506 (or some combination thereof) can comprise elements of the programming and the secure communication software 506. The secure communication data 507 can also be stored on the mass storage device 504. The secure communication data 507 can be stored in any of one or more databases known in the art. Examples of such databases comprise, DB2®, Microsoft® Access, Microsoft® SQL Server, Oracle®, mySQL PostgreSQL, and the like. The databases can be centralized or distributed across multiple systems.

In another aspect, the user can enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the one or more processors 503 via the human machine interface 502 that is coupled to the system bus 513, but can be connected by other interface and bus structures, such as a parallel port, game port, an IEEE 1394 Port (also known as a Firewire port), a serial port, or a universal serial bus (USB).

In yet another aspect, the display device 511 can also be connected to the system bus 513 via an interface, such as the display adapter 509. It is contemplated that the computer 501 can have more than one display adapter 509 and the computer 501 can have more than one display device 511. For example, the display device 511 can be a monitor, an LCD (Liquid Crystal Display), or a projector. In addition to the display device 511, other output peripheral devices can comprise components such as speakers (not shown) and a printer (not shown) which can be connected to the computer 501 via the Input/Output Interface 510. Any step and/or result of the methods can be output in any form to an output device. Such output can be any form of visual representation, including, but not limited to, textual, graphical, animation, audio, tactile, and the like. The display device 511 and computer 501 can be part of one device, or separate devices.

The computer 501 can operate in a networked environment using logical connections to one or more remote computing devices 514a,b,c. By way of example, a remote computing device can be a personal computer, portable computer, smartphone, a server, a router, a network computer, a peer device or other common network node, and so on. Logical connections between the computer 501 and a remote computing device 514a,b,c can be made via a network 515, such as a local area network (LAN) and/or a general wide area network (WAN). Such network connections can be through the network adapter 508. The network adapter 508 can be implemented in both wired and wireless environments. Such networking environments are conventional and commonplace in dwellings, offices, enterprise-wide computer networks, intranets, and the Internet.

For purposes of illustration, application programs and other executable program components such as the operating system 505 are illustrated herein as discrete blocks, although it is recognized that such programs and components reside at various times in different storage components of the computing device 501, and are executed by the one or more processors 503 of the computer. An implementation of the secure communication software 506 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for providing a secure display, comprising:
determining a security scheme associated with a decoding device;
accessing data,
modifying the data based on the security scheme; and
providing the modified data to a display device.

2. The method of claim 1, wherein determining a security scheme associated with a decoding device comprise detecting a setting of the decoding device.

3. The method of claim 2, wherein detecting a setting of the decoding device comprises detecting an identifier, a diffraction setting, a prism setting or a combination thereof using an optical sensor.

4. The method of claim 1, wherein modifying the data based on the security scheme comprise encrypting the data, encoding the data, or a combination thereof.

5. The method of claim 1, wherein modifying the data based on the security scheme comprises modifying the data to match a diffraction setting, a static pattern, an active/animated pattern, a prism setting, or a combination thereof.

6. The method of claim 1, further comprising displaying the data on the display device such that a user viewing the display device is unable to decipher the data without the decoding device.

7. The method of claim 1, wherein the decoding device comprises eyeglasses configured to receive the modified data as displayed to a user and convert the modified data back to the original data for viewing by the user.

8. The method of claim 1, wherein the display device comprises a screen on a vaping device.

9. The method of claim 1, wherein the display device comprises a screen on an electronic communication device configured with vaping functionality.

10. A method for interpreting a secure display, comprising:
receiving a signal from a computing display, wherein the signal comprises data encoded using a security scheme;
modifying the signal based on the security scheme; and
providing the modified signal to a user viewing the computing display.

11. The method of claim 10, wherein modifying the signal based on the security scheme comprises filtering the signal through a diffraction grating, a prism, or a combination thereof.

12. The method of claim 11, wherein the diffraction grating, the prism, or both are embedded in a lens.

13. The method of claim 10, wherein modifying the signal based on the security scheme comprises decoding the signal, decrypting the signal, or a combination thereof.

14. The method of claim 10, wherein providing the modified signal to the user viewing the computing display comprises channeling the modified signal to at least a portion of an eye of the user.

15. The method of claim 11, further comprising transmitting information indicative of the security scheme to a computing device in communication with the computing display.

16. The method of claim 15, wherein transmitting information indicative of the security scheme to a computing device in communication with the computing display comprises transmitting an identifier, an encryption key, a codec, or a combination thereof to the computing device.

17. The method of claim 10, wherein modifying the signal based on a security scheme comprises filtering an electromagnetic signal projected from the computing display.

18. The method of claim 17, wherein filtering the electromagnetic signal projected from the computing display comprising filtering based on polarity, frequency, or a combination thereof.

19. The method of claim 10, wherein the display comprises a screen on a vaping device.

20. A device comprising:
at least one lens;
a support frame configured to support the lens; and
a filter coupled to the lens and configured to modify information received from a display.
